(19) United States
(12) Patent Application Publication
(10) Pub. No.: US 2007/0171197 A1
(43) Pub. Date: Jul. 26, 2007

(54) Method for zooming image proportion of a mobile electronic apparatus and the mobile electronic apparatus using the same

(75) Inventors: Cheng-Shing Lai, Taipei (TW); Xiao-Long Fan, Nanking (CN); Green Zhao, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/653,965

(22) Filed: Jan. 17, 2007

(30) Foreign Application Priority Data
Jan. 17, 2006 (TW) 095101698

(51) Int. Cl. G09G 5/00; G08G 1/123

(52) U.S. Cl. 345/156; 340/995.16

(57) ABSTRACT

The present invention discloses a method for zooming image proportion of a mobile electronic apparatus, wherein the mobile electronic apparatus includes an accelerated displacement detector and a display screen and, when the mobile electronic apparatus is moved, the accelerated displacement detector will detect the physical properties of the movement of the mobile electronic apparatus, and then the mobile electronic apparatus will zoom an image displayed on the display screen to a certain proportion according to the physical properties. Thus, the operation of zooming in or out the image on the display screen can easily be achieved by moving the mobile electronic apparatus.

### FIELD OF THE INVENTION

The present invention relates to a method for zooming image proportion of a mobile electronic apparatus and the mobile electronic apparatus using the same, more particularly to a method applied to a mobile electronic apparatus having an accelerated displacement detector capable of detecting physical properties of the movement of the mobile electronic apparatus and zooming an image displayed on a display screen of the mobile electronic apparatus by a certain proportion according to movement data being detected.

### BACKGROUND OF THE INVENTION

At present, information technology and electronic industry are booming, various high-tech products derived from computers and mobile communications are developed rapidly, and all these are indispensable to our life and shorten the time and space between people. The market competition becomes increasingly severer, as electronic communication products such as mobile phones and personal digital assistants (PDA) become more popular and extensively used, and manufacturers spare no effort to promote their products. Major communication manufacturers constantly introduce innovative ideas and attractive features to the products, and thus the consumer requirements of the electronic communication products become increasingly higher. Therefore, it is an important index to determine whether or not the manufacturing technology of high-tech products of a country leads the others by its convenient and efficient services.

Some of the present PDAs available in the market have the feature of a map showing different districts of a city, so that a user can select a function of the PDA to view the map, and the name and sign of each road in the map will be shown in a window of the PDA to provide necessary travel information to users. If a desired location is not in the map, then the user needs to change the size of the map by executing such function of the PDA, and then press the zoom in/out function key or scroll the scroll bar by a touch pen to show the required area of a map. A user must hold the PDA by one hand and select the function keys by the other hand to look up a map. However, users may be restricted in certain situations (such as talking on a phone or driving), and this application will become inconvenient and have many drawbacks, and thus it is an important issue for manufacturers of the related industry to design a way of zooming image proportion of mobile electronic apparatus.

### SUMMARY OF THE INVENTION

In view of the foregoing shortcomings of the prior art, the inventor of the present invention based on years of experience to conduct extensive researches and experiments, and finally invented a method for zooming image proportion of mobile electronic apparatus in accordance with the present invention to satisfy consumer requirements of changing the size of a map quickly and improve the application procedure of changing the size of a map.

Therefore, it is a primary objective of the present invention to provide a method for zooming image proportion of a mobile electronic apparatus, wherein when the mobile electronic apparatus is moved, the physical properties of the moving mobile electronic apparatus will be detected, and the image displaced on a display screen of the mobile electronic apparatus will be zoomed according to the physical properties. Thus, the operation for zooming in or out a screen for the mobile electronic apparatus can be simply achieved by moving the mobile electronic apparatus.

Another objective of the present invention is to provide a mobile electronic apparatus capable of zooming images, and the apparatus includes an accelerated displacement detector and a display screen. If the mobile electronic apparatus is moved, the accelerated displacement detector will detect physical properties of the moving mobile electronic apparatus, and the mobile electronic apparatus will zoom the image displayed on the display screen in a proportion according to the physical properties.

To make it easier for our examiner to understand the objective, technical characteristics and effects of the present invention, a preferred embodiment will be described with accompanying drawings as follows:

### BRIEF DESCRIPTION OF THE DRAWINGS

FIG. 1 is a schematic block diagram of the present invention;

FIG. 2 is a flow chart of a preferred embodiment of the present invention;

FIG. 3 is another flow chart of a preferred embodiment of the present invention;

FIG. 4 is a proportion change table of the present invention;

FIG. 5 is a further flow chart of a preferred embodiment of the present invention; and

FIG. 6 is another further flow chart of a preferred embodiment of the present invention.

### DETAILED DESCRIPTION OF THE PREFERRED EMBODIMENTS

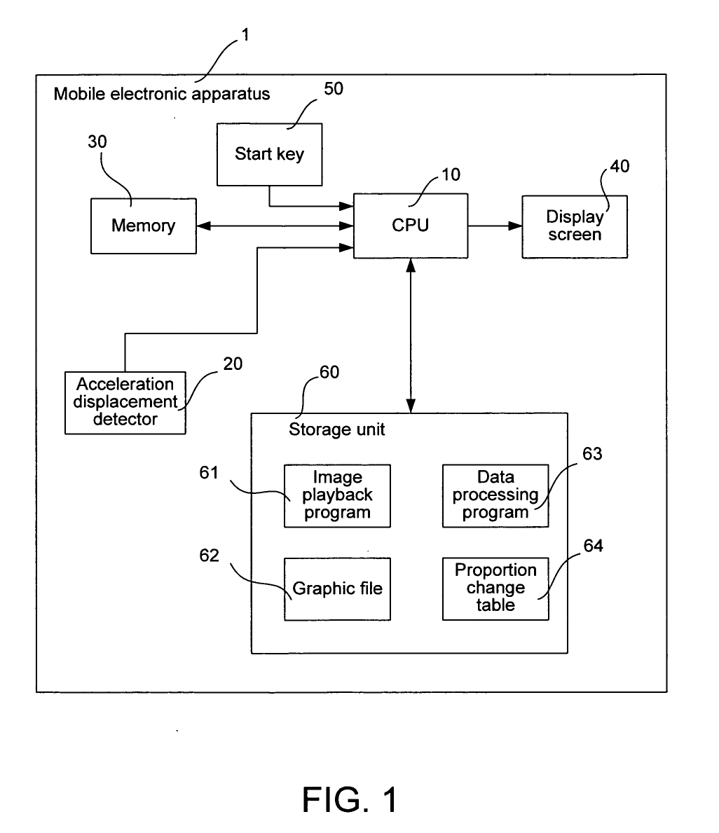

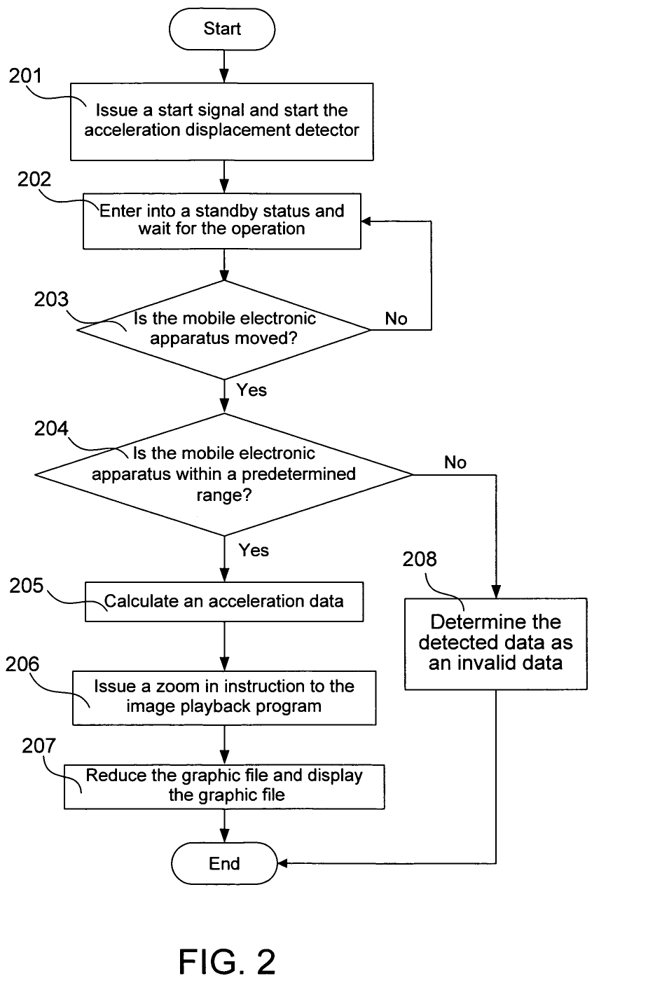

Referring to FIG. 1 for a preferred embodiment of the method for zooming image proportion of a mobile electronic apparatus and the mobile electronic apparatus using the same in accordance with the present invention, the mobile electronic apparatus 1 comprises a CPU 10, an accelerated displacement detector 20, a memory 30, a display screen 40, a start key 50, and a storage unit 60. The storage unit 60 comprises an image playback program 61, at least one graphic file 62, a data processing program 63, and a proportion change table 64. The accelerated displacement detector 20 can detect physical properties such as acceleration, direction and displacement of a moving mobile electronic apparatus 1 and generate and store a detected data according to the physical properties of the movement of said mobile electronic apparatus into the memory 30. If the image playback program 61 reads a graphic file 62 from at least one graphic file and displays the graphic file 62 on the display screen 40 as shown in FIG. 2, the CPU 10 will process the following procedure:

Step 201: The start key 50 can be pressed to issue a start signal to the accelerated displacement detector 20, and then start the accelerated displacement detector 20.

Step 202: The accelerated displacement detector 20 enters into a standby status and waits for its operation.

Step 203: The accelerated displacement detector 20 detects whether or not the mobile electronic apparatus 1 has a movement; if yes, then go to Step 204; or else go to Step 202.

Step 204: The accelerated displacement detector 20 sends the detected data to the memory 30 and determines whether or not the movement of the mobile electronic apparatus 1 is within a predetermined displacement range; if yes, then go to Step 205, or else go to Step 208.

Step 205: The CPU 10 executes the data processing program 63 to calculate an acceleration data according to the detected data stored in the memory 30.

Step 206: The CPU 10, calculates the proportion for zooming the image displaced on the display screen 40 according to the acceleration data and issues a zoom instruction to the image playback program 61 according to the comparison of the acceleration data with the proportion change table 64.

Step 207: The image playback program 61 zooms a graphic file 62 in a specific proportion to be display on the display screen 40.

Step 208: The following procedure will be stopped, if the CPU 10 determines that the detected data is an invalid data.

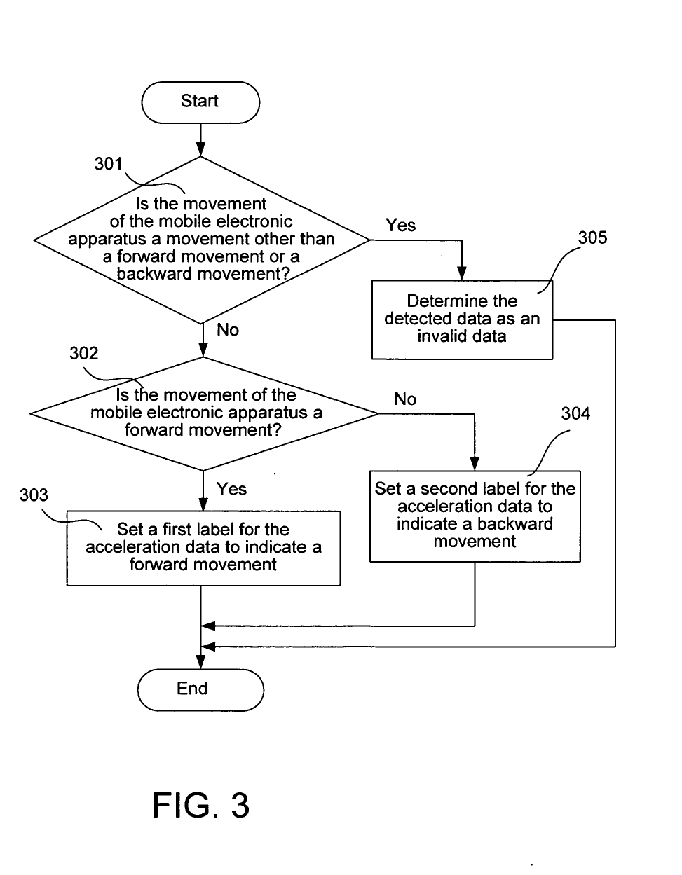

In the preferred embodiment of the present invention as shown in FIG. 1, the CPU 10 will carry out the following procedure according to the movement direction of the mobile electronic apparatus 1 as shown in FIG. 3, if the accelerated displacement detector 20 detects that the mobile electronic apparatus 1 has a movement:

Step 301: This step determines whether the movement of the mobile electronic apparatus 1 is a forward movement or a backward movement; if the movement is not a forward movement not a backward, go to Step 302, or else go to Step 305.

Step 302: This step determines whether or not the movement of the mobile electronic apparatus 1 is a forward movement; if yes, then go to Step 303, or else go to Step 304.

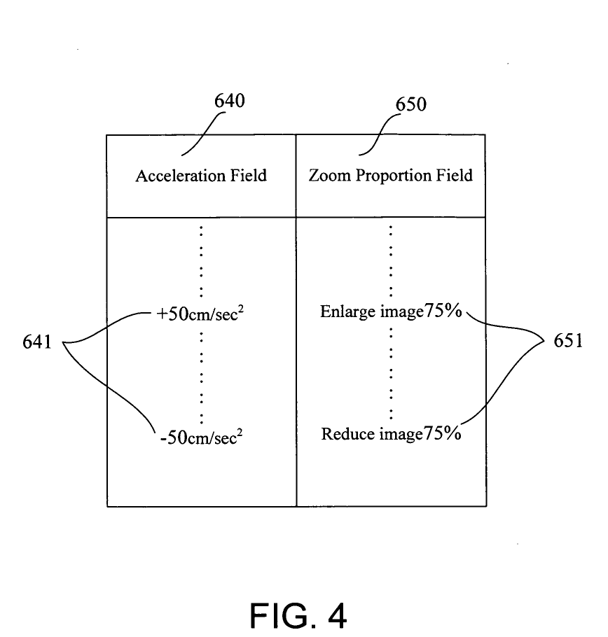

Step 303: The data processing program 63 sets a first label (and the acceleration data to be positive as shown in FIG. 4) for the calculated acceleration data to indicate a forward movement.

Step 304: The data processing program 63 will set a second label for the calculated acceleration (and the acceleration data is set to negative as shown in FIG. 4) to indicate a backward movement, if the movement of the mobile electronic apparatus 1 is determined to be a backward movement.

Step 305: The following procedure will be stopped, if the detected data is determined to be an invalid data.

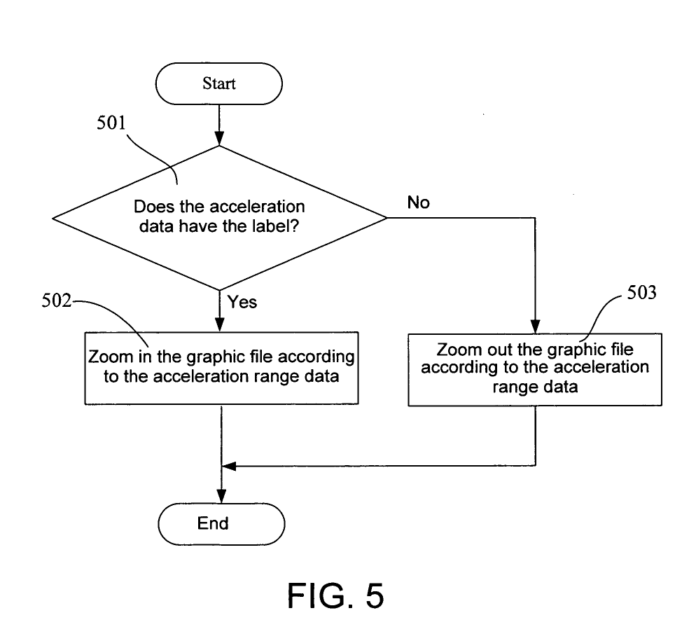

Referring to FIGS. 1 and 4 for a preferred embodiment of the present invention, the proportion change table 64 comprises an acceleration field 640 and a zoom proportion field 650. The acceleration field 640 includes a plurality of acceleration range data 641, and the zoom proportion field 650 includes a plurality of graphic zooming percentage data 651. The acceleration data matches with the first label (represented by a positive sign “+” in this embodiment) or the second label (represented by a negative sign “−” in this embodiment that represents a forward movement or a backward movement. Referring to FIG. 5, the procedure for the CPU 10 to determine according to the proportion change table 64 is described below:

Step 501: The acceleration range data 641 is compared with the acceleration data to determine whether the acceleration data has the first label; if yes, then go to Step 502, or else go to Step 503.

Step 502: The image playback program 61 zooms in the graphic file 62 to be displayed on the display screen 40 according to the graphic zooming percentage data 651 corresponding to the acceleration range data 641.

Step 503: if the acceleration data has the second label, the image playback program 61 will zoom out the graphic file 62 to be displayed on the display screen 40 according to the graphic zooming percentage data 651 corresponding to the acceleration range data 641.

To prevent users to zoom the proportion of the graphic file 62 displayed on the display screen 40 of the mobile electronic apparatus 1 by accident, the accelerated displacement detector 20 of the preferred embodiment of the present invention as shown in FIG. 1 will start detecting the detected data generated by the movement of the mobile electronic apparatus 1. If the accelerated displacement detector 20 determines that the mobile electronic apparatus 1 has a movement and the CPU 10 determines that the movement of the detected data does not fall within a predetermined displacement range (such as from 5 cm to 150 cm), then the CPU 10 will determine the detected data as an invalid data and stop the following procedure.

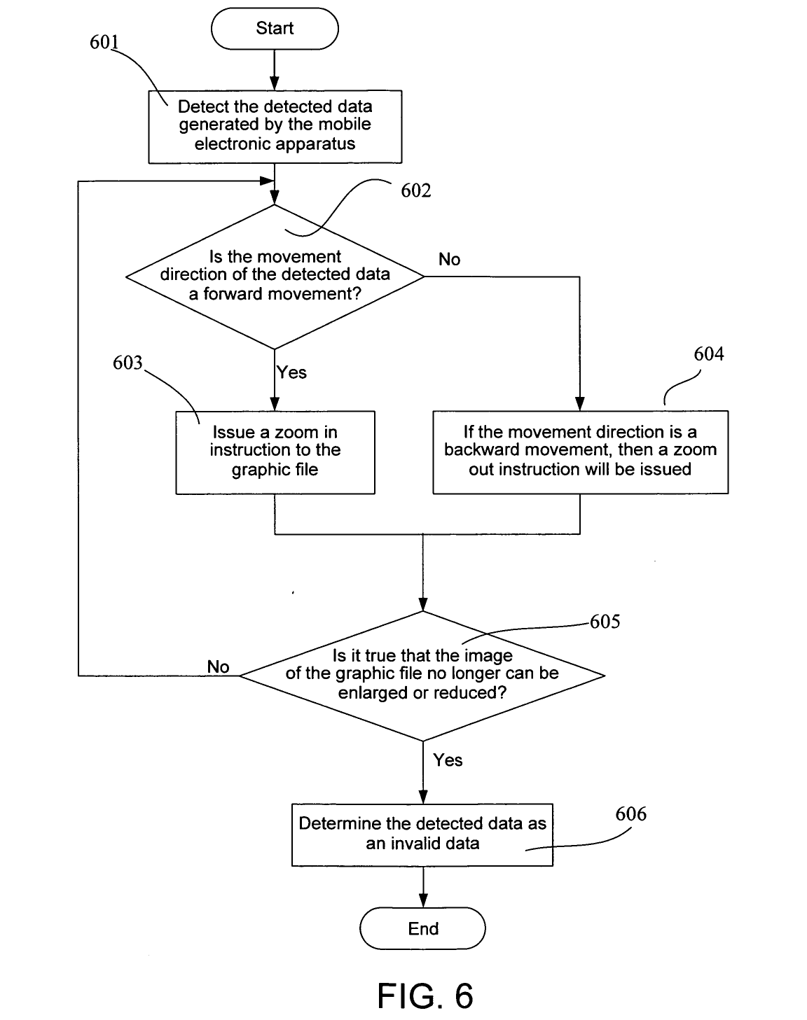

In FIG. 1, the zoom instruction of another preferred embodiment can include a zoom in instruction and a zoom out instruction, and the zoom in instruction enlarges the image of the graphic file 62 by a fixed proportion (such as (15%), and the zoom out instruction reduces the image of the graphic file 62 by a fixed proportion (such as 15%). If the accelerated displacement detector 20 determines that the mobile electronic apparatus 1 is moved, the CPU 10 will process the following procedure as shown in FIG. 6:

Step 601: The accelerated displacement detector 20 detects the detected data generated by the movement of the mobile electronic apparatus 1 and sends the detected data into the memory 30.

Step 602: This step determines whether the movement of the detected data stored in the memory 30 is a forward movement; if yes, then go to Step 603, or else go to Step 604.

Step 603: The image playback program 61 issues the zoom in instruction for enlarging the image by a fixed proportion to the graphic file 62 and then go to Step 605.

Step 604: This step determines that the movement of the detected data is a backward movement, and then the CPU 10 executes the image playback program 61 to issue a zoom out instruction for reducing the image of the graphic file 62 by a fixed proportion, and then go to Step 605.

Step 605: The image playback program 61 determines whether or not the image of the graphic file 62 no longer can be enlarged or reduced; if yes, then go to Step 606, or else go to Step 602.

Step 606: This step determines the detected data as an invalid data, and stops the following procedure.

In summation of the description above, the mobile electronic apparatus of the present invention can be any mobile electronic apparatus with a display screen for displaying the graphic file, and the mobile electronic apparatus is preferably a handheld communication device including but not limited to a mobile phone and a personal digital assistant (PDA).

While the invention herein disclosed has been described by means of specific embodiments, numerous modifications and variations could be made thereto by those skilled in the art without departing from the scope and spirit of the invention set forth in the claims.

What is claimed is:

1. A method for zooming image proportion of a mobile electronic apparatus, comprising the steps of:
detecting physical properties of a movement of said mobile electronic apparatus; and
zooming an image displayed on a display screen of said mobile electronic apparatus in a proportion according to said physical properties.

2. The method of claim 1, wherein said physical properties of the movement of said mobile electronic apparatus is detected by an accelerated displacement detector.

3. The method of claim 2, wherein said physical properties of the movement of said mobile electronic apparatus comprise acceleration, direction, and displacement of said mobile electronic apparatus.

4. The method of claim 3, further comprising the steps of:
generating a detected data according to said physical properties of a movement of said mobile electronic apparatus;
determining whether or not the movement of said mobile electronic apparatus is within a predetermined displacement range;
if yes, calculating an acceleration data according to the detected data; and
according to the acceleration data, calculating the proportion for zooming the image displaced on said display screen.

5. The method of claim 4, further comprising the steps of:
determining whether the movement of said mobile electronic apparatus is a forward movement or a backward movement;
if the movement is a forward movement, then setting a first label for the acceleration data, and
if the movement is a backforeard movement, then setting a second label for the acceleration data.

6. The method of claim 5, wherein
if the acceleration data is set the first label, then zoom in the image; and
if the acceleration data is set the second label, then zoom out the image.

7. The method of claim 5, if the movement is other than the forward movement or the backward movement, the method further comprising the step of:
determining the detected data as an invalid data and stopping the subsequent procedure.

8. A mobile electronic apparatus capable of zooming an image proportion, comprising:
an accelerated displacement detector, for detecting physical properties of a movement of said moving mobile electronic apparatus; and
a display screen, for displaying an image;
wherein, said mobile electronic apparatus zoom said image in a proportion according to said physical properties.

9. The mobile electronic apparatus of claim 8, further comprising an image playback program for reading a graphic file to be displayed on said display screen, zooming the image of the graphic file by a predetermined proportion, and displaying the image of the graphic file on said display screen.

10. The mobile electronic apparatus of claim 8, further comprising a proportion change table comprising at least an acceleration field and a zoom proportion field, and said acceleration field comprises a plurality of acceleration range data, and said zoom proportion field comprises a plurality of graphic zooming percentage data, and said acceleration data can go with a first label or a second label for indicating a forward movement or a backward movement of said moving mobile electronic apparatus according to the physical properties.

11. The mobile electronic apparatus of claim 8, further comprising a start key for being pressed to issue a start signal for said accelerated displacement detector and turn on said accelerated displacement detector when said image playback program reads the graphic file and displays said graphic file on said display screen.

12. The mobile electronic apparatus of claim 8, wherein said physical properties comprise acceleration, direction, and displacement of said movement of said mobile electronic apparatus.

13. The mobile electronic apparatus of claim 8, wherein said mobile electronic apparatus comprises a mobile phone or a personal digital assistant (PDA).
